(19) United States
(12) Patent Application Publication
(10) Pub. No.: US 2021/0406938 A1
(43) Pub. Date: Dec. 30, 2021

(54) INTELLIGENT SYSTEM RECOMMENDING USERS A USER ACTION AND A METHOD THEREOF

(71) Applicant: EDEE CIRCLE INC., Vestal, NY (US)

(72) Inventor: Anuj Thakral, Vestal, NY (US)

(73) Assignee: EDEE CIRCLE INC., Vestal, NY (US)

(21) Appl. No.: 17/317,962

(22) Filed: May 12, 2021

Related U.S. Application Data
(60) Provisional application No. 63/024,594, filed on May 14, 2020.

(51) Int. Cl. G06Q 30/02; G06Q 30/00; G06Q 10/00; G06Q 30/06; G06Q 20/36; G06Q 20/40

(52) U.S. Cl. CPC G06Q 30/0206; G06Q 30/018; G06Q 10/20; G06Q 20/4016; G06Q 30/0201; G06Q 30/0609; G06Q 20/36; G06Q 10/30

(57) ABSTRACT

An intelligent system and a method for recommending users to perform a user action based on a price determined for the electronic device by authenticating and verifying the electronic device, evaluating the condition of the electronic device, issuing a diagnosis report, determining the price for the electronic device, recommending the users to perform user action, performing the selected user action, and certifying the electronic device as a buy certified electronic device, a sell certified electronic device, and a repair certified electronic device.

### CROSS-REFERENCE TO RELATED APPLICATIONS

This application claims the benefit of U.S. provisional application No. 63/024,594 titled “An Intelligent System Recommending Users at least one User Action and Method Thereof” filed by the applicant on May 14, 2020, which is incorporated herein by reference in its entirety.

### FIELD OF THE INVENTION

Embodiments of the present invention relate to the field of electronic devices. More specifically, the present invention relates an intelligent system and method for recommending users to perform user action selected from recycling, selling or repairing of an electronic device based on a price evaluated for the electronic device.

### BACKGROUND OF THE INVENTION

The electronic device industry is one of the fastest growing sectors. With increasing technological development, there is an increased demand in electronic devices. In particular, the electronic devices include portable mobile electronic devices, such as mobile phones, laptop, notebooks, tablets, mp3 players, cell phones, PDA's, GPS devices, cameras, beepers, remote controls, cordless phones, calculators, etc. and non-portable electronic devices, such as computers, printers, and the like. In addition to electronic devices, the content based digital media such as games on CD, DVD, or cartridge, or entertainment mass storage items such as CDs, DVDs, Blu-Ray, etc. also have relatively high frequency replacement rates.

Particularly, the consumers upgrade and replace their mobile phones and other electronic devices with newer models and newer equipment more and more frequently to use the latest technological features. More often, the consumer either dispose of the prior electronic device in landfills or does not dispose of the prior electronic device, but rather just stops using it and begins using the new device. This may happen over several generations of such devices.

In both the situations, when the consumer just stops using a device and simply puts it in storage the opportunity for recycling or re-use by another party is lost and If the consumer just throws the device away in normal trash containers, the proper recycling or safe disposing of the device is thwarted.

In today's time, e-waste is one of the biggest problems faced by the world as the consumer improperly disposes the prior electronic device in landfills. This sector of e-waste is increasing at an alarming rate which is 3 times faster than traditional recycling materials, or on average, from 8.3% to 12% per year. In particular, E-waste refers to the electronic equipment discarded into the environment by the customer, if he feels that it has reached the end of its useful life. Thus, the customer discards large quantities of electronic devices into the environment.

Major concerns associated with improper discarding of electronic devices is leaching of hazardous materials such as plastics, lead, cadmium, mercury, etc. into the environment from electronic devices. Moreover, valuable metals such as gold, silver, etc. are also lost.

Other problems associated with E-waste recycling systems are that E-waste recycling systems are scarce, high cost for recycling, compounded with unclear regulation making the consumers experience very difficult. Thus, a very large quantity of E-waste is discarded into landfills.

United Patent Application US20170301035A1 titled “Kiosk for recycling electronic devices” filed on 2008 Oct. 2 focusses on a recycling kiosk for recycling and financial remuneration for submission of an electronic device.

Another U.S. Pat. No. 10,438,174B2 titled “Application for device evaluation and other processes associated with device recycling” filed on 2014 Oct. 2 focusses on systems and methods for mobile phones and/or other electronic devices to facilitate identification, evaluation, purchase, and/or other processes associated with recycling electronic devices in a kiosk.

Since, there are millions of outdated or broken mobile phones and other electronic devices are simply tossed into junk drawers or simply discarded into the environment. Thus, to overcome these problems associated with improper discarding of the electronic devices causing pollution or storing of electronic devices as junk.

There is a need to provide a solution which is encouraging the consumer to sell, repair or recycle the electronic device in a manner that is enticing and yet financially rewarding to the consumer. Thus, the present invention relates to an intelligent system recommending users to sell, repair or recycle based on a price determined for the electronic device by evaluating the condition of the electronic device. Moreover, the present invention aims at recycling, repairing and re-selling of the electronic devices so that they are not discarded into the environment, thereby decreasing the pollution and making the e-waste chain circular and saving the planet from toxic chemicals.

### SUMMARY OF THE INVENTION

An embodiment of the present invention relates to an intelligent system recommending a user to perform a user action based on a price determined for the electronic device. In particular, the user action is selected anyone from recycling, selling or repairing of an electronic device.

The intelligent system includes a selling device, a buying device, communication interface to allow communication of a one or more modules of a server with the seller device, the buyer device and a server. The server further comprises one or more databases to store data, a memory unit to store one or more modules and a processor

In particular, one or more databases include a user database, a buyer database, a seller database, an admin database, an electronic device database, an authentication database and alike database. And, one or more modules further includes an anti-theft module, a buyer module, a seller module, a recycling module, a repairing module and alike modules.

The seller module is operably configured to sell electronic device by initiating the selling request by a seller for the electronic device, requesting a seller dashboard interface from the server by the seller on a seller device, adding selling information of the electronic device on a seller dashboard for selling the electronic device, posting an advertisement deal for the electronic device by the seller with an expected price for the electronic device, receiving buying request from one or more buyers for the electronic device, connecting the seller with one or more buyers via the communication interface, receiving multiple offers from one or more buyers for the electronic device and accepting an offer of buyer from one or more buyers for the electronic device, facilitating a transaction between the buyer and the seller for the electronic device. In particular, the seller pays a transaction fee for every transaction between the buyer and the seller for the electronic device.

The buyer module is operably configured to buy the electronic device from the seller by initiating a buying request, requesting a buyer dashboard interface from the server on a buyer device to view a list of plurality advertisement deals for the electronic device posted by multiple sellers, selecting an advertisement deal from the list of plurality advertisement deals for the electronic device, comparing the electronic device with same/similar kind of electronic devices based on comparison features to make an offer, sending the offer to the seller based on the advertisement deal selected for the electronic device, and facilitating the transaction between the buyer and the seller by paying through any one payment methods. In particular, the payment method is selected from an internet banking, a debit card payment, a credit card payment, a digital wallet or a unified payment interface (UPI) and alike payment methods.

The anti-theft module is operably configured to determine whether the electronic device is a stolen electronic device. In particular, the anti-theft module executes steps by checking an authentication database for an International Mobile Equipment Identity (IMEI) number of the electronic device, verifying the International Mobile Equipment Identity (IMEI) number from the authentication database with the International Mobile Equipment Identity (IMEI) number on the electronic device and determining whether verification of the International Mobile Equipment Identity (IMEI) number is successful verification or an unsuccessful verification. In particular, the electronic device is authenticated on successful verification of the International Mobile Equipment Identity (IMEI) number. Moreover, the electronic device is rejected as the stolen device on unsuccessful verification.

The repairing module is configured to perform steps of initiating the repairing request by the user for the electronic device based on the diagnosis report, automatically determining nearby repair stores for repairing of one or more one damaged component of the electronic device based on a GPS location of the electronic device and a geographical location of a user, recommending and displaying one or more nearby repair stores on the dashboard in anyone of view selected from a list view and a map view, selecting a nearby mobile repair shop from the list of nearby mobile repair shops and view the nearby mobile repair shop information. In particular, the nearby mobile repair shop information includes name and description, an exact location, a distance from the user, a contact number, a rating and one or more images of the nearby mobile repair shop. Moreover, the diagnosis report highlights the damaged component of the electronic device, the age of the electronic device, battery status of the electronic device and compatibility of use of the electronic device in other countries. Further, the nearby mobile repair shops are displayed in a list view or in a geographical Postal Index Number (PIN) map view.

The recycling module is configured to initiate the recycling request and specify device specific details. In particular, the device specific details include quantity of electronic devices, model of electronic device, condition of the electronic device, mode of shipment, shipment date, shipment time and alike electronic device details in the recycling request.

The lost mode module enables the seller to lock the electronic device by sending a lock command from the seller dashboard and disable the electronic device when the electronic device is lost and/or stolen and/or not delivered to the buyer.

The computer-readable media having computer-executable instructions stored thereon that are executable by the processor to perform the steps of authenticating and verifying the electronic device by the anti-theft module, evaluating the electronic device on multiple evaluating features to determine the price of the electronic device, issuing the diagnosis report informing the user a status of working features of the electronic device, certifying the electronic device, recommending the user to perform a user action based on the price determined for the electronic device, initiating a request to perform user action, and performing user action selected from selling, repairing or recycling of the electronic device. In particular, the request is selected from a selling request, a repairing request, and a recycling request based on the price determined for the electronic device.

The communication interface that is operably configured for communicating with the server, one or more modules, seller device, buyer device.

In accordance with an embodiment of the present invention, the electronic device is anyone of a mobile phone, smartphones, a handheld device, laptops, computers, tablets, personal computer, a mobile computer, a game console and alike electronic devices.

In accordance with one or more embodiments of the present invention, the user is selected from an admin user, a guest user, a registered user, a subscribed user, a non-subscribed user, a seller, a buyer and alike users. And, the user device is anyone of a buyer device and a seller device. In particular, the user device may include but are not limited to mobile phone, smartphone, handheld device, laptop, computer, tablet, personal computer, mobile computer, game console, smart device and alike user devices.

In accordance with another embodiment of the present invention, the intelligent system certifies the electronic device as buy certified electronic device, sell certified electronic device, or repair certified electronic device by comparing a market price of the electronic device with the price determined for the electronic device, and determining using a determination marker whether the price determined of the electronic device is higher than the market price, lower than the market price, similar to the market price.

In particular, the intelligent system recommends the seller to initiate the selling request for the electronic device when the price determined by the determination marker price for the electronic device is higher than the market price or similar to the market price. And, the intelligent system recommends the seller to initiate the recycling request for the electronic device when the price determined by the determination marker price for the electronic device is lower than the market price.

In accordance with another embodiment of the present invention, the evaluating features is selected from stolen status of the electronic device, Warranty of the electronic device, Locking and Unlocking of the electronic device, Multi-touch feature, camera pixels, Camera, Video recording, Microphone, External speaker, Flash light, buttons of the electronic device, Touch ID, Face ID, Wi-Fi, Bluetooth, Data call Digitiser, Voice call, Proximity sensor, Light sensor, Motion sensor, GPS sensor and a like parameters.

Further, the intelligent system comprises an artificial intelligence (AI) Chat bot adapted to be utilized by the buyer via the buyer device for automatically negotiating the price of the electronic device with the seller.

Another embodiment of the present invention relates to a method recommending the user to perform any user action selected from recycling, selling or repairing of an electronic device based on a price determined for the electronic device. The method includes authenticating and verifying the electronic device by an anti-theft module, evaluating a condition of the electronic device on multiple evaluating features to determine the price of the electronic device, issuing a diagnosis report informing the user a status of working features of the electronic device, determining the price for the electronic device based on the diagnosis report, recommending the user to perform user action based on the price determined for the electronic device, initiating a request selected from a selling request, a repairing request, and a recycling request to perform the user action, performing anyone of user action selected from the selling, the repairing and the recycling of the electronic device. and certifying the electronic device as a buy certified electronic device, a sell certified electronic device, and a repair certified electronic device.

In particular, the seller and/or the user initiates the selling request for the electronic device if the price determined by the determination marker for the electronic device is similar to the market price or higher to the market price. The seller and/or user initiates the recycling request if the price determined by the determination marker for the electronic device is lower than the market price.

In accordance with an embodiment of the present invention, the method is configured to authenticate and verify the electronic device by checking an authentication database for an International Mobile Equipment Identity (IMEI) number of the electronic device, verifying the International Mobile Equipment Identity (IMEI) number from the authentication database with the International Mobile Equipment Identity (IMEI) number on the electronic device and determining whether verification of the International Mobile Equipment Identity (IMEI) number is successful verification or an unsuccessful verification. In particular, the electronic device is authenticated on successful verification of the International Mobile Equipment Identity (IMEI) number. Moreover, the electronic device is rejected as the stolen device on unsuccessful verification.

In accordance with one embodiment of the present invention, the method is configured to perform selling of the electronic device by initiating the selling request by a seller for the electronic device, requesting a seller dashboard interface from the server by the seller on a seller device, adding selling information of the electronic device on a seller dashboard for selling the electronic device, posting an advertisement deal for the electronic device by the seller with an expected price for the electronic device, receiving buying request from one or more buyers for the electronic device, connecting the seller with one or more buyers via the communication interface, receiving multiple offers from one or more buyers for the electronic device and accepting an offer of buyer from one or more buyers for the electronic device, facilitating a transaction between the buyer and the seller for the electronic device. In particular, the seller pays a transaction fee for every transaction between the buyer and the seller for the electronic device.

In accordance with an embodiment of the present invention, the method is further configured to buy the electronic device from the seller by initiating a buying request, requesting a buyer dashboard interface from the server on a buyer device to view a list of plurality advertisement deals for the electronic device posted by multiple sellers, selecting an advertisement deal from the list of plurality advertisement deals for the electronic device, comparing the electronic device with same/similar kind of electronic devices based on comparison features to make an offer, sending the offer to the seller based on the advertisement deal selected for the electronic device, and facilitating the transaction between the buyer and the seller by paying through any one payment methods. In particular, the payment method is selected from an internet banking, a debit card payment, a credit card payment, a digital wallet or a unified payment interface (UPI) and alike payment methods.

In accordance with yet another embodiment of the present invention, the method further includes steps of initiating the repairing request by the user for the electronic device based on the diagnosis report, automatically determining nearby repair stores for repairing of one or more damaged component of the electronic device based on a GPS location of the electronic device and a geographical location of a user, recommending and displaying one or more nearby repair stores on the dashboard in anyone of view selected from a list view and a map view, selecting a nearby mobile repair shop from the list of nearby mobile repair shops and view the nearby mobile repair shop information. In particular, the nearby mobile repair shop information includes name and description, an exact location, a distance from the user, a contact number, a rating and one or more images of the nearby mobile repair shop. Moreover, the diagnosis report highlights the damaged component of the electronic device, the age of the electronic device, battery status of the electronic device and compatibility of use of the electronic device in other countries. Further, the nearby mobile repair shops are displayed in a list view or in a geographical Postal Index Number (PIN) map view.

In accordance with yet another embodiment of the present invention, the method further includes initiating the recycling request by the user for the electronic device and specifying device specific details in the recycling request, selecting anyone mode of shipment selected from a nearby recycling store mode and a postal service mode, receiving an expected delivery time for collecting the electronic device from the user via the selected mode of shipment for recycling. In particular, device specific details in the recycling request include a quantity of the electronic devices, a model of electronic device, the condition of the electronic device, the mode of shipment, a shipment date, a shipment time and alike electronic device details.

In accordance with an embodiment of the present invention, the method further comprises a step of disabling the electronic device when the electronic device is lost and/or stolen and/or not delivered to the at least one buyer by sending a lock command from the seller dashboard by the at least one seller to lock the electronic device.

The foregoing objectives of the present invention is attained by incorporating an intelligent system for recommending a user to perform a user action based a price determined for the electronic device and the method thereof.

### BRIEF DESCRIPTION OF THE DRAWINGS

So that the manner in which the above recited features of the present invention is be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a block diagram illustration of an exemplary system within which various aspects of the present disclosure can be implemented, in accordance with one or more embodiments of the present invention;

FIG. 1B is a block diagram illustrating a schematic configuration of the modules in accordance with one or more embodiments of the present invention;

FIG. 2 is a flow chart illustrating a method for recommending users to perform a user action based on the price determined for the electronic device in accordance with one or more embodiments of the present invention;

FIG. 3 is a flow chart illustrating a method recommending users to perform a user action based on the price determined for the electronic device in accordance with one or more embodiments of the present invention;

FIG. 4 is a flow chart illustrating the method for authenticating and verifying the electronic device in accordance with one or more embodiments of the present invention;

FIG. 5 is a flow chart illustrating a method to perform the selling of the electronic device in accordance with one embodiment of the present invention;

FIG. 6 is a flow chart illustrating a method to perform the buying of the electronic device in accordance with another embodiment of the present invention;

FIG. 7 is a flow chart illustrating a method to perform the repairing of the electronic device in accordance with yet another embodiment of the present invention;

FIG. 8 is a flow chart illustrating a method to perform the recycling of the electronic device in accordance with yet another embodiment of the present invention.

### ELEMENT LIST

Intelligent System 100
Processor 105
Memory Unit 110
Database 115
Communication interface 125
Server 130
User Device 135
Modules 140
Anti-Theft Module 150
Seller module 155
Buyer module 160
Recycling Module 165
Lost Mode Module 170
Repairing Module 175

### DETAILED DESCRIPTION

The following invention disclosure illustrates various embodiments of software application (“app”) an intelligent system and method for recommending multiple users to perform user action selected from recycling, selling or repairing of the electronic device based on the price determined for the electronic device.

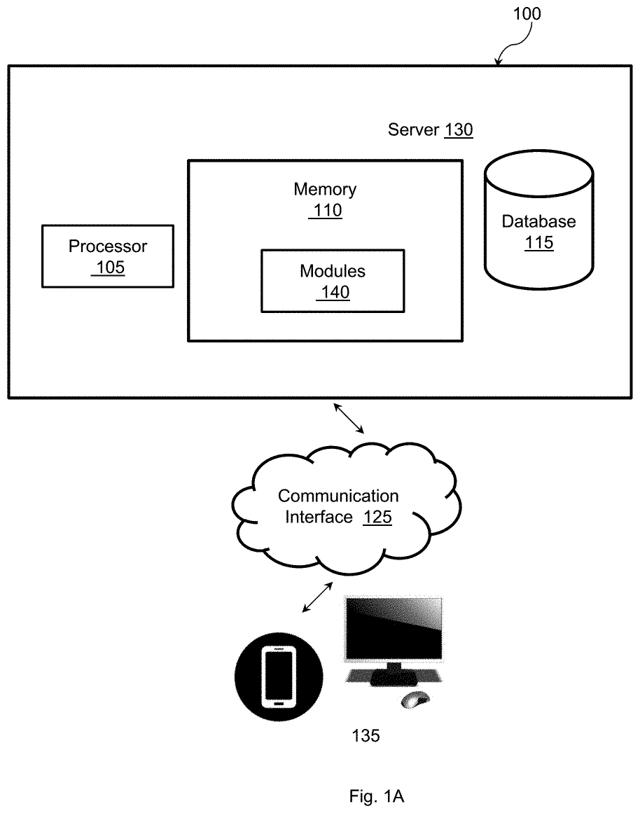

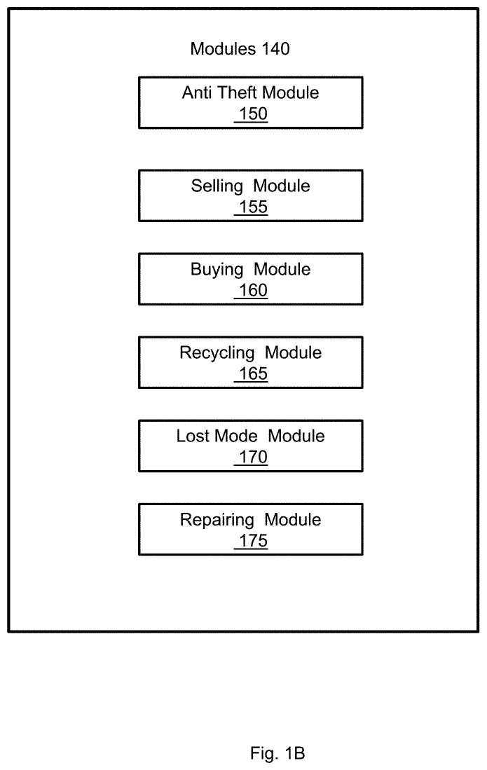

The principles of the present invention and their advantages are best understood by referring to FIG. 1A to FIG. 8. In the following detailed description of illustrative or exemplary embodiments of the disclosure, specific embodiments in which the disclosure may be practiced are described in sufficient detail to enable those skilled in the art to practice the disclosed embodiments.

The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

Referring to FIG. 1A, particularly the reference numbers denoting parts, FIG. 1A illustrates an intelligent system 100 recommending users/sellers/buyers to perform a user action based on a price determined for the electronic device. In particular, the user selects any user action selected from recycling, selling or repairing of an electronic device. The intelligent system includes a selling device, a buying device, (a communication interface 125 to allow communication of a one or more modules of a server with the seller device, the buyer device (hereinafter referred as user device 135) and a server 130. The server 130 further comprises one or more databases (hereinafter referred as database 115) to store data, a memory unit to store one or more modules (hereinafter referred as module 140) and a processor 105.

The intelligent system 100 includes a server 130 having one or more databases (hereinafter referred as database 115) and a memory unit 110 with one or more modules (hereinafter referred as module 140), a dashboard interface, a communication interface 125. configured to represent various forms of servers including, but not limited to a web server, an application server, a proxy server, a communication interface server, a server farm and so forth.

Embodiments of the present invention are intended to include or otherwise cover any type of server 130, including known, related art, and/or later developed technologies.

The database 115 stores data including but not limited to user details, buyer details, electronic device details, user credentials, seller details, admin details, payment details, price determining parameters, nearby mobile repair shop details, evaluating features list, transaction details, diagnosis reports, price determined, International Mobile Equipment Identity (IMEI) numbers and alike details. In particular, the database 115 further includes a user database, a buyer database, a seller database, an admin database, an electronic device database, a payment database, an authentication database and alike databases.

The memory unit 110 is configured to store module 140. In particular, the module 140 includes an anti-theft module 150, a seller module 155, a buyer module 160, a recycling module 165, a lost mode module 170, a repairing module 175 and alike modules. (Refer FIG. 1B)

The computer-readable media having computer-executable instructions stored thereon that are executable by the processor 105 to perform steps of authenticating and verifying the electronic device by an anti-theft module, evaluating the electronic device on one or more evaluating features to determine the price of the electronic device, issuing a diagnosis report informing the user a status of working features of the electronic device, certifying the electronic device as a buy certified electronic device, a sell certified electronic device, or a repair certified electronic device, recommending the user to perform the user action selected from selling, buying or repairing based on the price determined for the electronic device, initiating a request selected from a selling request, a repairing request, or a recycling request to perform the user action and performing selling, repairing or recycling of the electronic device.

The communication interface 125 allows communication between the module 140 of the server 130, seller device, buyer device. Particularly, the communication interface 125 is but not limited to, the Internet, wireless networks, local area networks, wide area networks, private networks, a cellular communication network, corporate network having one or more wireless access points or a combination thereof connecting any number of mobile clients, fixed clients, and servers and so forth.

Examples of communication interface 125 may include the Internet, a WIFI connection, a Bluetooth connection, a Zigbee connection, a communication network, a wireless communication network, a 3G communication network, a 4G communication network, a 5G communication network, a 6G communication network, a 7G communication network, a USB connection, or any combination thereof.

For example, the communication may be based through a radio-frequency transceiver (not shown). In addition, short-range communication may occur, such as using Bluetooth, Wi-Fi, or other such transceivers.

In some implementations, the intelligent system 100 may be a distributed client/server system that spans one or more communication networks (not shown).

In some implementations, the server 130 can communicate with the intelligent system 100 via a virtual private network (VPN), Secure Shell (SSH) tunnel, or other secure network connection.

The intelligent system 100 further includes a dashboard interface for sending push notifications to the user. In particular, the push notification is anyone of the notification selected from a Broadcast notification, an advertisement deal expiration notification, an email verification notification, a notification for a new customer showing interest in the deal, a Dispute raised notification, an amount debited notification, an credited notification, a Dispute raised notification, Dispute resolved notification, Amount refunded notification. Alternatively, the user may disable the dashboard interface to stop sending and receiving push notifications.

Particularly, the dashboard interface is configured to display multiple information to the user in user profile such as but not limited to a list of certificates with validity of the certificate, saved payment methods, saved card details, saved bank account details, the subscription Plans, transaction details including, received transactions, sent transactions. Moreover, transaction details includes the date of transactions, name and model of the electronic device in the transaction. Furthermore, the list of certificates includes all the certificates purchased by the users with the electronic device details along with the date of expiration of the certificate.

The dashboard interface displays a list of the recycling requests with information including number of electronic devices, date and time of recycling request, donation status of the electronic devices, status of the recycling request and/or buying requests with information including number of electronic devices, date and time of buying request, status of the buying request and/or selling requests with information including number of electronic devices, date and time of selling request, status of the selling request and/or a list of the repairing requests with information including number of electronic devices, date and time of repairing request, status of the repairing request.

In accordance with an embodiment of the present invention, the user is anyone of an admin user, a guest user, a registered user, a subscribed user, a non-subscribed user, a seller, a buyer and alike users.

In accordance with an embodiment of the present invention, a guest user views only the Home option. To access other options like advertisement option, buying option, comparing option, nearby repairing shops, top deals, location option, searching feature option or recycling option, the guest user creates a user profile and registers as a registered user.

The user may be a registered user after creating a user profile. In particular, the user profile has multiple data fields including a profile image, name of the user location of the user phone number email id. Moreover, the user details like mobile number and email address is verified by sending a 4 digit numeric OTP. After successful verification of the OTP the user profile is created, and the user is registered as the registered user. Moreover, the registered user signs in into the system using his credentials including an email & a password. The registered user resets the password by adding a valid email ID, receiving an email with a link on the registered email, creating a new password and login with a new password.

The user may be a non-subscribed user are registered users and have access to all the features but can post only 2 advertisements with a validity period of 15 days.

The subscribed users have purchased a subscription plan and have to access all the features and can post ads depending on the type of subscription plan.

The admin user controls and manages the advertisements deals of the electronic devices received from the seller. Moreover, the radius of location for displaying the advertisement deals to the buyers is set by the admin. Furthermore, the admin earns by certifying the authenticity of the device by running diagnostics.

In accordance with an embodiment of the present invention, the user is a seller and a buyer at the same time.

In particular, each of the user device being associated with one of users. Particularly, the user device 135 can communicate with each other through the communication interface 125 or wirelessly through a communication network which may include digital signal processing circuitry. Moreover, each of user device 135 can represent various forms of processing devices.

Example user device 135 can include a desktop computer, a laptop computer, a user computer, a tablet computer, a personal digital assistant (PDA), a cellular telephone, a communication interface appliance, a camera, a smartphone, an enhanced general packet radio service (EGPRS) mobile phone, a media player, a navigation device, an email device, a game console, or a combination of any these data processing devices or other data processing devices. Furthermore, the user device 135 can be provided access to and/or receive application software executed and/or stored on any of the server 130.

In accordance with another embodiment of the present invention, the intelligent system 100 certifies the electronic device as buy certified electronic device, sell certified electronic device, or repair certified electronic device by comparing a market price of the electronic device with the price determined for the electronic device, and determining using a determination marker whether the price determined of the electronic device is higher than the market price, lower than the market price, similar to the market price.

Particularly, the intelligent system 100 recommends the seller to initiate the selling request for the electronic device when the price determined by the determination marker for the electronic device is higher than the market price and/or similar to the market price. Moreover, the intelligent system 100 recommends the seller to initiate the recycling request for the electronic device when the price determined by the determination marker for the electronic device is lower than the market price.

In accordance with an embodiment of the present invention, the determination marker determines the price of the electronic device based on price determining parameters. In particular, the price determining parameters are but not limited to the base price of the electronic device, battery health of the electronic device, model year of the electronic device, warranty status of the electronic device, lost and stolen status of the electronic device. In particular, the base price is the minimum value the user gets if all the evaluating features fails in the diagnosis. The battery health is determined by evaluating the battery life of the electronic device.

Subsequently, based on the model year of the electronic device there is a 20% decrease in the price determined of the electronic device every year for 5 year.

And, after 5 years, the model year of the electronic device is not considered as the parameter.

Additionally, the warranty status of the electronic device adds value to the electronic device. So, if the electronic device has warranty then the system adds 100% value otherwise 0% value.

Alternatively, the lost and stolen status of the electronic device adds value to the electronic device after authenticating and verifying the electronic device. If the electronic device is the stolen electronic device 0% value is added to the value to the electronic device. And, if the device is not the stolen electronic device then 100% value is added to the value to the electronic device.

In an exemplary example, if the criteria for IMEI number, electronic device model, warranty, battery life and alike criteria is not met then there is a 20% decrease in the price determined for the electronic device.

Table 1 is an exemplary example illustrating the price of the electronic device determined by the intelligent system based on one or more price determining parameters:

TABLE 1
Price Determination of electronic devices based on Price Determining Parameters

| | iPhone XS Max | iPhone XS Max | iPhone XS Max |
|---|---|---|---|
| Device | (Device 1) | (Device 2) | (Device 3) |
| Market Price | $1000 | $1000 | $1000 |
| Minimum Base | $200 | $200 | $200 |
| Price (20%) | | | |
| In Warranty | YES | NO | NO |
| (20%) | $200 (100/100)*200 = | $200 (0/100)* 200 = | $200 (100/100)* 200 = |
| | 200 | 0 | 0 |
| Battery life | 80% Battery Life | 80% Battery Life | 70% Battery Life |
| (20%) | $200 | $200 | $200 |
| | (80/100)*200 = 160 | (80/100)* 200 = 160 | (70/100)* 200 = 175 |
| Model year | Model year 2019 | Model year 2018 | Model year 2018 |
| (20%) | $200 | $250 | $250 |
| | (80/100)*200 = | (60/100)* 200 = | (60/100)* 200 = |
| | 160 | | 150 |
| Is Stolen or | If not stolen $200 | If not stolen $200 | If stolen $250 |
| Lost (20%) | (100/100)*200 = 200 | (100/100)*1000 = 200 | (0/100)*1000 = 0 |
| Final price | $920 | $680 | $525 |

Table 2 is an exemplary example illustrating the price of the electronic device determined by the intelligent system 100 based on the weightage of one or more evaluating features. In particular, the intelligent system 100 detects the non-working evaluating feature of the electronic device and degrades the price of the electronic device by the weightage of the evaluating feature. In particular, the evaluating feature includes but not limited to, stolen status of the electronic device, Warranty of the electronic device, Locking and Unlocking of the electronic device, Multi-touch feature, camera pixels, Camera, Video recording, Microphone, External speaker, Flash light, buttons of the electronic device, Touch ID, Face ID, Wi-Fi, Bluetooth, Data call Digitizer, Voice call, Proximity sensor, Light sensor, Motion sensor, GPS sensor and a like parameters.

TABLE 2
Price Determination of electronic devices based
on a Weightage of the Evaluating Features

| | iPhone XS Max | iPhone XS Max | iPhone XS Max |
|---|---|---|---|
| Feature | (Device 1) | (Device 2) | (Device 3) |
| Price (From above) | $920 | $680 | $525 |
| Locked or Not | Unlocked | Unlocked | Unlocked |
| (Weightage 10) | | | |
| Multi-Touch | Working | Working | Working |
| (Weightage 5) | | | |
| Dead pixels | No | Yes (10/)*680 = | No |
| (Weightage 10) | | $56.4−$56.4 | |
| Video recording | Working | Working | Working |
| (Weightage 10) | | | |
| Microphone | Working | Not working (10/)*680 = | Working |
| (Weightage 10) | | $56.4−$56.4 | |
| Front camera | Working | Working | Working |
| (Weightage 10) | | | |
| Back camera | Working | Working | Working |
| (Weightage 10) | | | |
| External speaker | Working | Working | Not working (5/)* 525 = |
| (Weightage 5) | | | $21.5−$21.5 |
| Flash | Working | Working | Not working (5/)* 525 = |
| (Weightage 5) | | | $21.5−$21.5 |
| Touch ID/FaceID | Working | Working | Networking (10/)* |
| (Weightage 10) | | | 525 = |
| | | | $43.05−$43.05 |
| Wi-Fi | Working | Working | Working |
| (Weightage 5) | | | |
| Bluetooth | Working | Working | Working |
| (Weightage 5) | | | |
| Proximity sensor | Working | Working | Working |
| (Weightage 5) | | | |
| Light sensor | Working | Working | Working |
| (Weightage 5) | | | |
| GPS | Working | Working | Working |
| (Weightage 5) | | | |
| Motion sensor | Working | Working | Working |
| (Weightage 5) | | | |
| Compass | Working | Working | Working |
| (Weightage 5) | | | |
| Final price | $920 | $567.2 | $438.95 |
| (Weightage) | | | |

In accordance with one or more embodiments of the present invention, the intelligent system 100 allows sellers and buyers to communicate with each other using a chat box. In particular, the chat box displays information such as seller name, buyer name, last message with date & time and number of unread messages. Moreover, the recent chat threads are shown on the top of the chat box. Furthermore, new chat threads would not be visible on either side until the first message is exchanged between users. Also, seller and buyer exchange text files like pdf or doc and media files like images.

Further, the seller and buyer may save chat thread, or delete chat thread. And, the seller may select chat threads from a list of chat threads of multiple buyers interested in the selected advertisement deal.

The seller may raise the payment request from the buyer using the chat thread, then the payment request is displayed on the chat screen with two options “Decline” option and “Pay Now” option. If the buyer clicks on the “Pay Now” option, then then the transaction is completed.

For shipping in the United States, a charge is automatically calculated, and the shipping label is automatically generated and shared with the buyer. For countries like India where there is no organized postal service, the label is not generated automatically and in this case the seller has to add the service provider name, receipt and shipping number.

Alternatively, if the buyer selects the “Decline” option then the transaction is cancelled.

In accordance with one or more embodiments of the present invention, the chat box is an artificial intelligence (AI) Chat bot is provided as part of messaging window at the webpage and/or mobile application. Particularly, the artificial intelligence (AI) Chat bot is adapted to be utilized by the user (buyer) via the user device 135 (buyer device) for automatically negotiating the price of the electronic device with the seller. Moreover, the artificial intelligence (AI) chat bot utilizes learning algorithms and/or models and sentiment analysis for negotiating the price of the electronic device. Additionally, the artificial intelligence (AI) chat bot may be capable of determining, tracking the status of the electronic device and spontaneously or upon request responding in a conversation with one or more users.

Alternatively, the artificial intelligence (AI) chat bot may further answer the concerns and problems of the user and/or buyer based on available big data and reviewing a response from the seller and/or buyer using a combination of scripting and artificial intelligence.

Referring to FIG. 1B, the anti-theft module 150 is operably configured to determine whether the electronic device is a stolen electronic device. In particular, the anti-theft module 150 checks an authentication database for an International Mobile Equipment Identity (IMEI) number of the electronic device, verifies the International Mobile Equipment Identity (IMEI) number from the authentication database with the International Mobile Equipment Identity (IMEI) number on the electronic device and determines whether verification of the International Mobile Equipment Identity (IMEI) number is successful verification or an unsuccessful verification.

In one embodiment if the determination is “YES” and the verification of the International Mobile Equipment Identity (IMEI) number electronic device is successful, the electronic device is automatically accepted as “Not Stolen Device”. In particular, the electronic device is authenticated and accepted by the anti-theft module 150 as “Not Stolen Device”.

In another embodiment if the determination is “NO” and the verification of the International Mobile Equipment Identity (IMEI) number electronic device is unsuccessful, then the electronic device is automatically rejected by the anti-theft module 150 as the “Stolen Device”.

In accordance with an embodiment of the present invention, the seller module 155 is operably configured to sell electronic device by initiating the selling request by a seller for the electronic device, requesting a dashboard interface (seller dashboard) from the server 130 by the seller on user device 135 (seller device), adding selling information of the electronic device on a seller dashboard for selling the electronic device, posting an advertisement deal for the electronic device by the seller with an expected price for the electronic device, receiving buying request from one or more buyers for the electronic device, connecting the seller with one or more buyers via the communication interface, receiving multiple offers from one or more buyers for the electronic device and accepting an offer of anyone buyer from one or more buyers for the electronic device, facilitating a transaction between the buyer and the seller for the electronic device. In particular, the seller pays a transaction fee for every transaction between the buyer and the seller for the electronic device.

In accordance with an embodiment of the present invention, the buyer module 160 is operably configured to buy the electronic device from the seller by initiating a buying request, requesting a dashboard interface (buyer dashboard) from the server 130 on the user device 135 (buyer device) to view a list of plurality advertisement deals for the electronic device posted by multiple sellers, selecting an advertisement deal from the list of plurality advertisement deals for the electronic device, comparing the electronic device with same/similar kind of electronic devices based on comparison features to make an offer, sending the offer to the seller based on the advertisement deal selected for the electronic device, and facilitating the transaction between the buyer and the seller by paying through any one payment methods. In particular, the payment method is selected from an internet banking, a debit card payment, a credit card payment, a digital wallet or a unified payment interface (UPI) and alike payment methods.

In particular, the user saves one or more cards for card payments. For the debit card payment, and the credit card payment, the user can save card details of one or more debit cards and credit cards. In particular, the saved card details include Card Name, Card Number, Expiry Date and CVV and alike details for fast payment. Moreover, the user selects any one of the debit cards and credit cards as a primary card for payments. Subsequently, the user deletes cards details of any one of the saved debit cards and saved credit cards at any time.

The user may save one or more bank accounts for internet banking payments. For internet banking payments, the user adds bank account details of one or more bank accounts. In particular, the saved bank details include Name of the Account Holder, Bank Name, Sort Code, IFSC Code, Bank address, CIF number, a five-digit branch code, country code, registered mobile number and alike details. Moreover, the user selects any one of the bank accounts as a primary bank account for fast payments. Furthermore, the user receives the payment from another user in the primary bank account. Subsequently, the user deletes the bank account details of any one of the saved bank accounts at any time.

In accordance with an embodiment of the present invention, the transaction is facilitated by scanning the QR code.

In accordance with an embodiment of the present invention, the recycling module 165 is configured to initiate the recycling request and specify device specific details. In particular, the device specific details include quantity of electronic devices, model of electronic device, condition of the electronic device, mode of shipment, shipment date, shipment time and alike electronic device details in the recycling request.

In accordance with an embodiment of the present invention, the lost mode module 170 enables the seller to lock the electronic device by sending a lock command from the seller dashboard and disable the electronic device when the electronic device is lost and/or stolen and/or not delivered to the buyer. Also, the lost mode module 170 enables the seller to track and send the last known location to the buyer.

In accordance with an embodiment of the present invention the repairing module 175 performs steps of initiating the repairing request by the user for the electronic device based on the diagnosis report, automatically determining nearby repair stores for repairing of one or more one damaged component of the electronic device based on a GPS location of the electronic device and a geographical location of a user, recommending and displaying one or more nearby repair stores on the dashboard in anyone of view selected from a list view and a map view, selecting a nearby mobile repair shop from the list of nearby mobile repair shops and view the nearby mobile repair shop information. In particular, the nearby mobile repair shop information includes name and description, an exact location, a distance from the user, a contact number, a rating and one or more images of the nearby mobile repair shop.

In accordance with one embodiment of the present invention, the list of nearby mobile repair shops keeps on updating and adding more nearby mobile repair shops as the user scrolls down the list. Moreover, the user can filter the list of nearby mobile repair shops based on one or more filtering parameters such as type of the phone, distance of the stores from user location, ratings of the stores and alike filtering parameters.

In accordance with another embodiment of the present invention, the nearby mobile repair shops are displayed in the map view. In particular, the map view is a geographical Postal Index Number (PIN) map view. Moreover, in the map view the multiple nearby mobile repair shops are displayed with the geographical Postal Index Number (PIN) of the nearby mobile repair shop.

In accordance with an embodiment of the present invention, the user can run the diagnosis again to cross check the report suggested by the system. In particular, the diagnosis report informs the user the working status of one or more evaluating features. And, the evaluating features is selected from stolen status of the electronic device, warranty of the electronic device, electronic device model, electronic device battery life, electronic device variant/capacity, locking and unlocking of the electronic device, multi-touch feature, dead pixels, camera, video recording, microphone, external speaker, flash light and buttons of the electronic device, Touch ID, face ID, Wi-Fi, Bluetooth, data call, digitizer, voice call, proximity sensor, light sensor, motion sensor, GPS sensor and a like parameters. Also, the diagnosis report highlights one or more damaged components of the electronic device. Furthermore, the diagnosis report provides the age of the electronic device, battery status of the electronic device and compatibility of use of the electronic device in other countries.

In accordance with one or more embodiments of the present invention, the intelligent system 100 may be operably configured with a smart portal from which that information can be accessed to locate the nearest repair shops based on the GPS location of the electronic device.

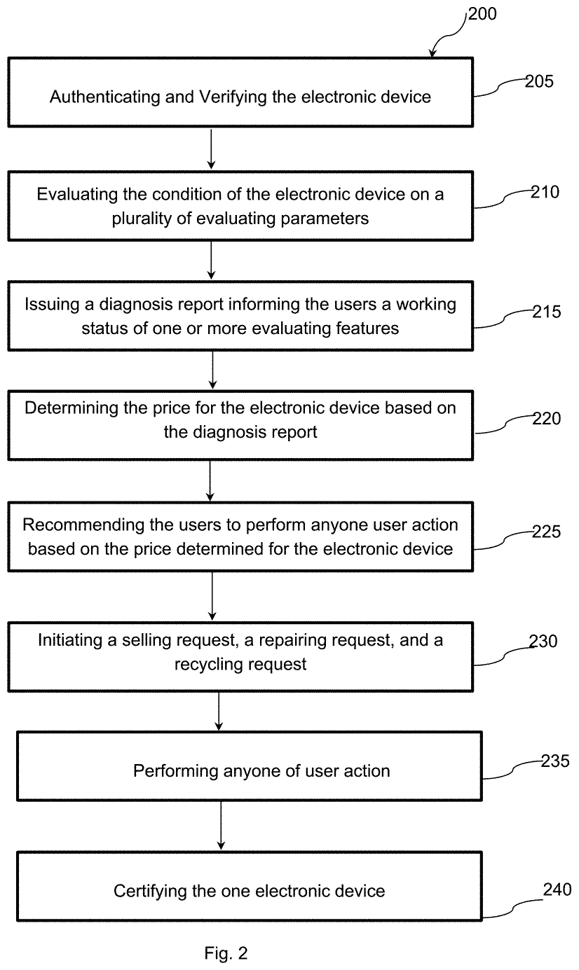

FIG. 2 is a flow chart illustrating a method recommending multiple users to perform user action based on the price determined for the electronic device in accordance with one or more embodiments of the present invention. Particularly, user action is selected from selling, repairing or recycling of an electronic device.

The method 200 starts at step 205. At step 205, the electronic device is authenticated and verified by an anti-theft module. Step 205 proceeds to step 210. At step 210, the condition of the electronic device is evaluated on multiple evaluating features. In particular the multiple evaluating features is selected from stolen status of the electronic device, warranty of the electronic device, locking and unlocking of the electronic device, Multi-touch feature, camera pixels, Camera, Video recording, Microphone, External speaker, Flash light, buttons of the electronic device, touch ID, Face ID, Wi-Fi, Bluetooth, Data call digitizer, Voice call, Proximity sensor, Light sensor, Motion sensor, GPS sensor and a like parameters.

Step 210 proceeds to step 215. At step 215, a diagnosis report is issued to the users based on the evaluation of the electronic device. In particular, the diagnosis report informs the user the working status of one or more evaluating features. Moreover, the diagnosis report highlights one or more damaged components of the electronic device. Furthermore, the diagnosis report provides the age of the electronic device, battery status of the electronic device and compatibility of use of the electronic device in other countries. The evaluating features is selected from stolen status of the electronic device, Warranty of the electronic device, electronic device model, electronic device battery life, electronic device variant/capacity, locking and unlocking of the electronic device, multi-touch feature, dead pixels, camera, video recording, microphone, external speaker, flash light and buttons of the electronic device, Touch ID, face ID, Wi-Fi, Bluetooth, data call, digitizer, voice call, proximity sensor, light sensor, motion sensor, GPS sensor and a like parameters

Step 215 proceeds to step 220. At step 220, the price for the electronic device is determined based on the diagnosis report. In particular, a diagnosis report is issued after evaluating the electronic device to the sellers. Moreover, the diagnosis report informs the user the working status of one or more evaluating features. Furthermore, the diagnosis report highlights one or more damaged components of the electronic device. And, the diagnosis report provides the age of the electronic device, battery status of the electronic device and compatibility of use of the electronic device in other countries.

Step 220 proceeds to step 225. At step 225, the users are recommended to perform user action based on the price determined for the electronic device. In particular, the user action selected from selling, repairing or recycling of an electronic device.

Step 225 proceeds to step 230. At step 230, a request is initiated by the user. In particular, the request is selected from a selling request, a repairing request, and a recycling request based. Moreover, the type of request is based on the user action recommended to the user.

Step 230 proceeds to step 235. At step 235, anyone of user action selected from the selling, the repairing and the recycling of the electronic device is performed based on the anyone request initiated by the user.

Step 235 proceeds to step 240. At step 240, a certificate for the electronic device is issued. In particular, the certificate certifies the electronic device as a buy certified electronic device, a sell certified electronic device, and a repair certified electronic device.

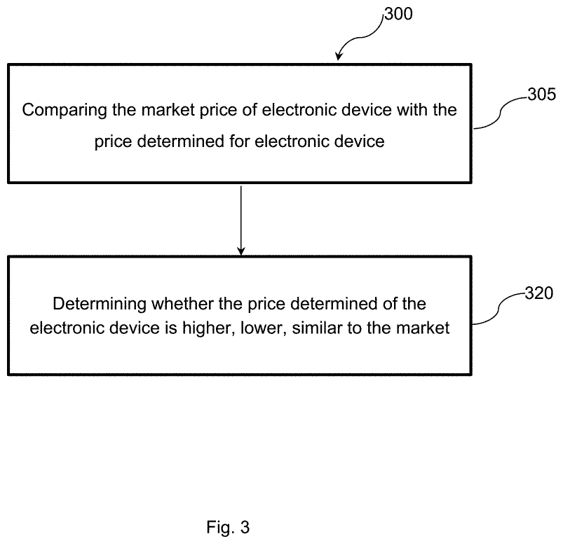

FIG. 3 is a flow chart illustrating a method for recommending users to perform user action based on the price determined for the electronic device in accordance with one or more embodiments of the present invention. The method 300 starts at step 305 and proceeds to step 310.

At step 305, the market price of the electronic device is compared with the price determined for the electronic device. And at step 310, a determination is made whether the price determined of the electronic device is higher than a market price, lower than the market price, similar to the market price. In particular, the determination is made using a determining marker.

In accordance with one embodiment of the present invention, if the determination marker indicates that the determined price for the electronic device is similar and/or to the market price then the user initiates the selling request for the electronic device.

In accordance with another embodiment of the present invention, if the determination marker indicates that the determined price for the electronic device is lower to the market price, then the user initiates the recycling request for the electronic device.

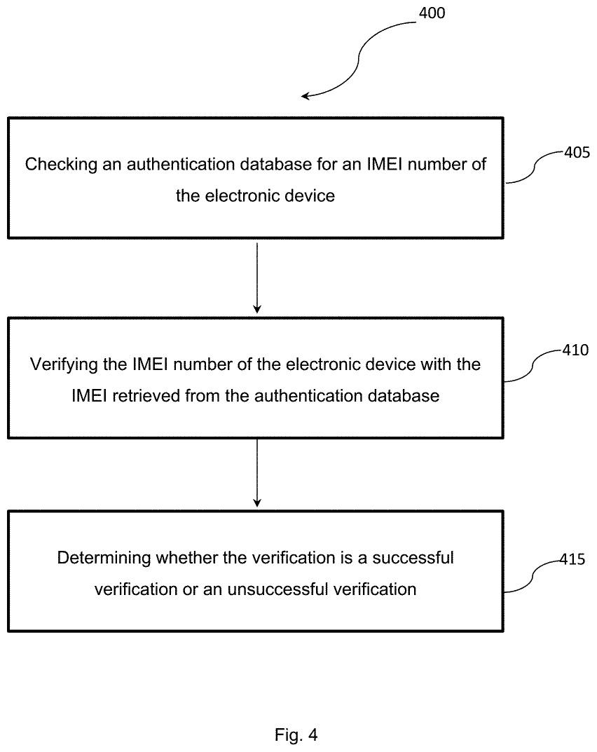

FIG. 4 is a flow chart illustrating the method for authenticating and verifying the electronic device in accordance with one or more embodiments of the present invention. In particular, the authentication and verification of the electronic device by an anti-theft module 150.

The method 400 starts at step 405. At step 405, the International Mobile Equipment Identity (IMEI) number of the electronic device is checked on an authentication database. In particular, the authentication database has a record of IMEI numbers, multiple device identifiers for stolen electronic devices.

Step 405 proceeds to step 410. At step 410, the International Mobile Equipment Identity (IMEI) number from the authentication database is verified with the International Mobile Equipment Identity (IMEI) number on the electronic device.

Step 410 proceeds to step 415. At step 415, a determination is made whether the verification of International Mobile Equipment Identity (IMEI) number is successful.

In one embodiment if the determination is “YES” and the verification of the International Mobile Equipment Identity (IMEI) number electronic device is successful, the electronic device is automatically accepted as “Not Stolen Device”.

In particular, the electronic device is automatically accepted as “Not Stolen Device” proceeds to perform the steps of method 200.

In another embodiment if the determination is “NO” and the verification of the International Mobile Equipment Identity (IMEI) number electronic device is unsuccessful, then the electronic device is automatically rejected as the “Stolen Device”.

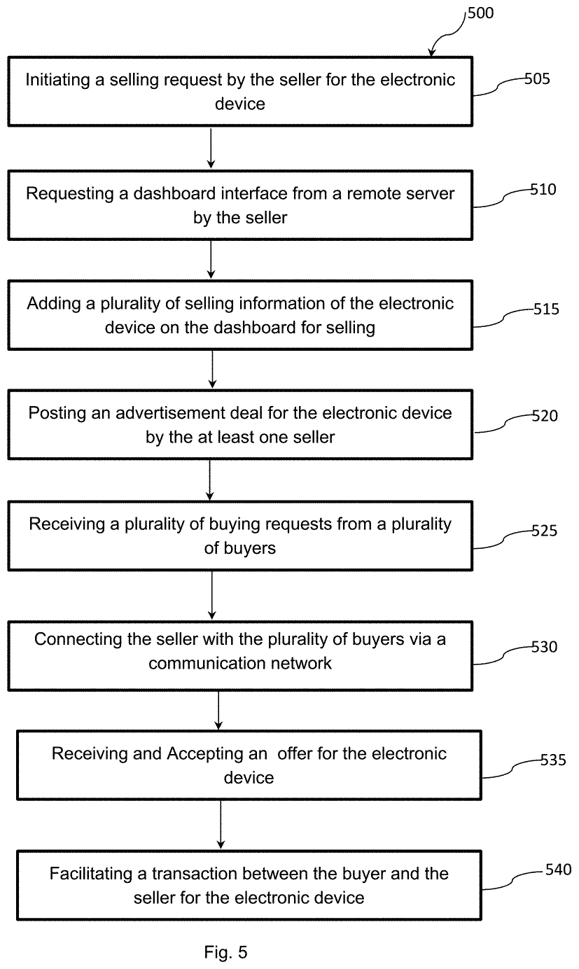

FIG. 5 is a flow chart illustrating a method to perform the selling of the electronic device in accordance with one embodiment of the present invention. The method 500 starts at step 505. At step 505 a selling request is initiated by the seller for the electronic device.

Step 505 proceeds to step 510. At step 510, a dashboard interface (seller dashboard) is requested from the server 130 by the seller on the user device 135 (seller device).

Step 510 proceeds to step 515. At step 515, multiple selling information of the electronic device is added by the seller. In particular, the seller fills the selling information on the seller dashboard for the electronic device. Moreover, after filling the adding basic information, the estimated price for the electronic device is determined. The seller may edit the estimated price or may proceed with the determined price for the electronic device.

In accordance with one embodiment of the present invention, the seller may add electronic devices to the list manually by manually filling the selling information on the electronic device and manually confirming that the electronic device is not a stolen device and not involved in any illegal activity. In particular, the selling information includes brand Name, Device type, Model, Variant, phone OS details, geolocation, Price, Description, Images, Accessories details Headphone, Charger and alike information.

In accordance with another embodiment of the present invention, the seller may add the electronic device to the list after running diagnosis of the electronic device and evaluating the condition of the electronic device on multiple evaluating features.

In accordance with one or more embodiments of the present invention, the seller also fills details like specific regions for selling the electronic device with an expected price amount.

Step 515 proceeds to step 520. At step 520, an advertisement deal for the electronic device is posted by the seller. Particularly, the advertisement deal of the electronic device displays images of the electronic device, advertisement status, number of views, sell certified device certificate badge, advertisement date, sell certified device certificate badge and the like deal information. Moreover, the status of the advertisement deal may be displayed in a featured advertisement, an active advertisement and an inactive advertisement.

In accordance with one embodiment of the present invention, the seller may change the status of the inactive advertisement to the active advertisement by paying extra money to reactivate the advertisement deal. In particular, the advertisement is active for 15 days and the seller can re-active it again.

In accordance with one embodiment of the present invention, the seller may change the status of the advertisement deal to featured advertisement by paying extra money. In particular, the featured advertisement is displayed on the top in the list. Moreover, the featured advertisement is active for 30 Days.

In accordance with one or more embodiments of the present invention, based on GPS coordinates of the user device paid advertisements are displayed first on the user device and then unpaid advertisements.

Step 520 proceeds to step 525. At step 525, multiple buying requests are received by the seller from multiple buyers for the electronic device.

Step 525 proceeds to step 530. At step 530, the seller is connected with one or more buyers via a communication interface 125.

Step 530 proceeds to step 535. At step 535, multiple offers are received form one or more buyers for the electronic device. In particular, the seller accepts the offer of any one buyer for the electronic device.

Step 535 proceeds to step 540. At step 540, a transaction is facilitated between the buyer and the seller for the electronic device. In particular, the seller pays a transaction fee for every transaction between the buyer and the seller for the electronic device. Moreover, on receiving the payment from the buyer the seller ships the electronic device to the buyer. Further, the seller shares shipping details with the buyer. The shipment information includes shipping date, shipping address, shipping status, shipping receipt, shipping number and shipping agency.

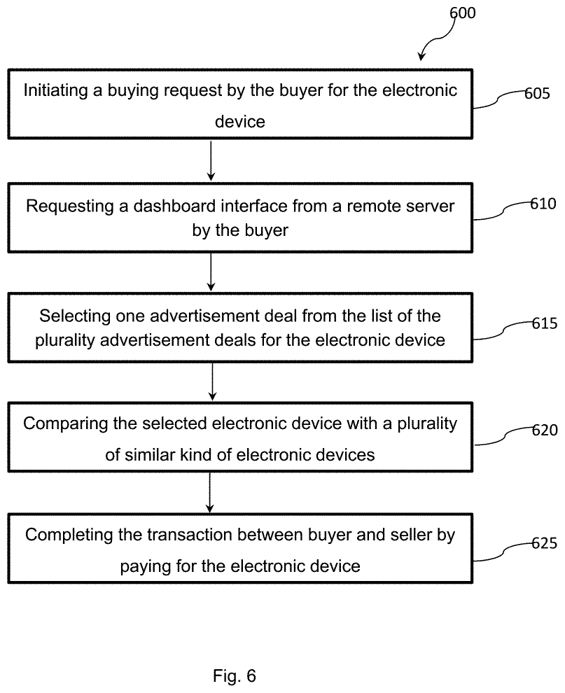

FIG. 6 is a flow chart illustrating a method to perform the buying of the electronic device in accordance with another embodiment of the present invention. In particular, the method 600 starts at step 605. At step 605, the buying request is initiated by the buyer for the electronic device.

Step 605 proceeds to step 610. At step 610, the dashboard interface (buyer dashboard) is requesting from the server 130 to view the list multiple advertisement deals for the electronic devices posted by multiple sellers.

Step 610 proceeds to step 615. At step 615, one advertisement deal is selected from the list of the plurality advertisement deals for the electronic device. In particular, the buyer retrieves and views one or more selling information and the estimated price of the selected advertisement deal. Moreover, the selling information includes brand name, device type, model, variant, phone OS details, geolocation, price, description, images, accessories details headphone, charger and alike information.

In particular, the buyer views the advertisement deals in his geographical location and/or in another location by selecting that geographical region on the map. Moreover, the advertisement deal of the electronic device displays images of the electronic device, advertisement status, number of views, sell certified device certificate badge, advertisement date, sell certified device certificate badge and the like deal information.

Step 615 proceeds to step 620. At step 620, the selected electronic device is compared with similar kinds of electronic devices to make the offer to the seller. In particular, the electronic devices are compared on multiple comparison parameters such as but not limited to highlight, display condition, hardware specifications and alike parameters.

In accordance with an embodiment of the present invention, the buyer directly selects the electronic device from the list of relevant electronic devices and compares with the electronic device based on multiple comparison parameters. In particular, a list of relevant electronic devices is displayed to the user. Moreover, the user compares the used electronic device with one of the relevant electronic devices from the list of relevant electronic devices based on multiple features.

In an exemplary example, the user searches for iPhone XR, then all the relevant results for the phone iPhone XR are displayed in a list for comparison. The buyer compares all the searched relevant results for iPhone XR results based on display condition selected as the comparison parameter.

In accordance with yet another embodiment of the present invention, the buyer filters the list of the electronic device based on multiple buying parameters selected from price, system certified mobile devices, brand, ram, storage, screen size, primary camera, secondary camera and alike parameters. Moreover, the buyer selects at least two or more buying parameters to filter the list of relevant results. The buyer views the filtered relevant used electronic devices based on the selected two or more filtering parameters.

Step 620 proceeds to step 625. At step 625, the transaction is completed between the buyer and the seller, when the buyer pays for the electronic device. In particular, the transaction is facilitated when the seller accepts the offer made by the buyer for the electronic device. Moreover, the transaction is completed when the buyer pays for the electronic device to the seller. Furthermore, the payment is done through anyone payment methods selected from an internet banking, a debit card payment, a credit card payment, a digital wallet or a unified payment interface (UPI) and alike payment methods.

The user may save one or more cards for card payments. For the debit card payment, and the credit card payment, the user can save card details of one or more debit cards and credit cards. In particular, the saved card details include Card Name, Card Number, Expiry Date and CVV and alike details for fast payment. Moreover, the user selects any one of the debit cards and credit cards as a primary card for payments. Subsequently, the user deletes cards details of any one of the saved debit cards and saved credit cards at any time.

The user may save one or more bank accounts for internet banking payments. For internet banking payments, the user adds bank account details of one or more bank accounts. In particular, the saved bank details include Name of the Account Holder, Bank Name, Sort Code, IFSC Code, Bank address, CIF number, a five-digit branch code, country code, registered mobile number and alike details. Moreover, the user selects any one of the bank accounts as a primary bank account for fast payments. Furthermore, the user receives the payment from another user in the primary bank account. Subsequently, the user deletes the bank account details of any one of the saved bank accounts at any time.

In accordance with an embodiment of the present invention, the transaction is facilitated by scanning the QR code.

In accordance with one or more embodiments of the present invention, the buyer views the list electronic devices, top deals electronic devices and featured electronic devices. In particular, top deals electronic devices are the trending and in demand electronic devices. Moreover, the featured electronic devices are high end value electronic devices. Furthermore, the paid advertisements are displayed first to the buyers based on the buyer's geographical location.

In accordance with one or more embodiments, the buyer can select anyone from Mark as received, Report Seller and Raise dispute.

In particular, the buyer selects the function Mark as received after receiving the electronic device within a predefined duration of 7 days from purchasing.

Alternatively, the buyer selects the function Report Seller for reporting the seller and specify the reason for reporting the seller.

Alternatively, the buyer selects the function Raise dispute, when the buyer has not received the electronic device within the estimated time duration or has received a damaged electronic device. In particular, the buyer upload media images files on receiving a damaged purchased used electronic device.

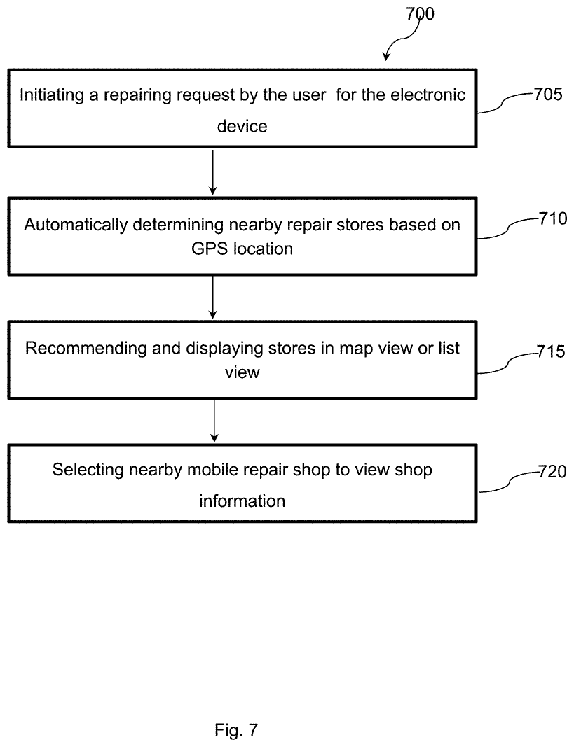

FIG. 7 is a flow chart illustrating a method to perform the repairing of the electronic device in accordance with yet another embodiment of the present invention.

The method 700 starts at step 705. At step 705 the repairing request is initiated by the user. In particular, the user initiates the request to repair the electronic device based on the diagnosis report. The diagnosis report informs the user the working status of one or more evaluating features. Furthermore, the diagnosis report highlights one or more damaged components of the electronic device. And, provides the age of the electronic device, battery status of the electronic device and compatibility of use of the electronic device in other countries.

Step 705 proceeds to step 710. At step 710, nearby repair stores are automatically determined for repairing the damaged component of the electronic device based on the GPS location of the electronic device and a geographical location of a user.

Step 710 proceeds to step 715. At step 715 multiple nearby repair stores are recommended to the user and are displayed on the dashboard interface. In particular, the multiple nearby mobile repair shops are displayed in anyone view selected from a list view and a map view.

In accordance with one embodiment of the present invention, the view selected by the user for displaying is the list view. In particular, the dashboard interface displays the list of nearby mobile repair shops. Moreover, the list keeps on updating more nearby mobile repair shops as the user scrolls down the list. Furthermore, the user can filter the list of nearby mobile repair shops based on one or more filtering parameters. One or more filtering parameters is selected from Type of the phone, distance of the stores from your location, ratings of the stores and alike filtering parameters.

In accordance with another embodiment of the present invention, the view selected by the user for displaying is the map view. In particular, the map view is a geographical Postal Index Number (PIN) map view. Moreover, in the map view the multiple nearby mobile repair shops are displayed with the geographical Postal Index Number (PIN) of the nearby mobile repair shop.

Step 715 proceeds to step 720. At step 720, a nearby mobile repair shop is selected from the multiple nearby mobile repair shops by the user to view the nearby mobile repair shop information. In particular, the mobile repair shop information includes the name of the nearby mobile repair shops, description of the nearby mobile repair shops, exact location and distance of the nearby mobile repair shops from the user, contact number of the nearby mobile repair shops, rating of the nearby mobile repair shops and the images of the of nearby mobile repair shops.

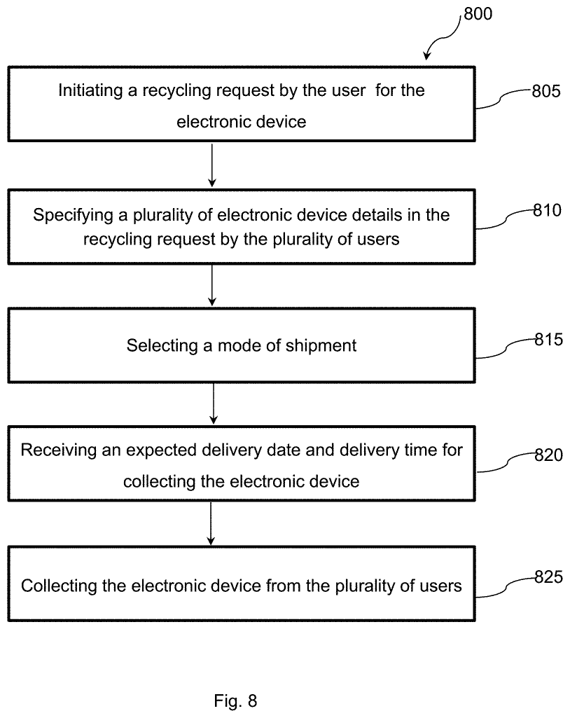

FIG. 8 is a flow chart illustrating a method to perform the recycling of the electronic device in accordance with yet another embodiment of the present invention. The method 800 starts at step 805. At step 805, the recycling request is initiated by the user for the electronic device.

Step 805 proceeds step 810. At step 810, one or more electronic device details is specified in the recycling request by the user. In particular, one or more electronic device details includes a quantity of the electronic devices, a model of electronic device, the condition of the electronic device, shipment details and alike electronic device details. The shipment information includes shipping date, shipping address, shipping status, shipping receipt, shipping number and shipping agency.

Step 810 proceeds to step 815. At step 815, a mode of shipment is selected from a nearby recycling store mode and a postal service mode by the user.

Step 815 proceeds to 820. At step 820, an expected delivery date and delivery time for collecting the electronic device is received by the user.

In accordance with an embodiment of the present invention, a diagnosis certificate is issued for the repaired electronic device evaluating whether the electronic device is worth repairing. If the electronic device is not worth repairing, it is sent for recycling.

In accordance with an embodiment of the present invention, the sellers sell the certified electronic devices and the buyer buys the certified electronic devices.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

What is claimed for:

1. An intelligent system for recommending a user action based on a price determined for an electronic device, wherein the intelligent system comprising:
a seller device;
a buyer device;
a communication interface to allow communication of a one or more modules of a server with the seller device, the buyer device; and
the server further comprising:
one or more databases to store data; and
a memory unit to store one or more modules;
a processor; and
a computer-readable media having computer-executable instructions stored thereon that are executable by the processor to perform steps of:
authenticating and verifying the electronic device by an anti-theft module;
evaluating the electronic device on one or more evaluating features to determine the price of the electronic device;
issuing a diagnosis report informing the user a status of working features of the electronic device;
certifying the electronic device as a buy certified electronic device, a sell certified electronic device, or a repair certified electronic device;
recommending the user to perform the user action selected from selling, buying or repairing based on the price determined for the electronic device;
initiating a request selected from a selling request, a repairing request, or a recycling request to perform the user action; and
performing selling, repairing or recycling of the electronic device.

2. The intelligent system as claimed in claim 1, wherein the intelligent system certifies the electronic device as the buy certified electronic device, the sell certified electronic device, or the repair certified electronic device by:
comparing a market price of the electronic device with the price determined for the electronic device; and
determining using a determination marker whether the price determined of the electronic device is higher than market price, lower than market price, similar to market price.

3. The intelligent system as claimed in claim 2, wherein the intelligent system recommends the user to initiate:
the selling request for the electronic device when the price determined by the determination marker for the electronic device is higher than the market price or similar to market price; and
the recycling request for the electronic device when the price determined by the determination marker for the electronic device is lower than market price.

4. The intelligent system as claimed in claim 1, wherein a seller module is operably configured to sell electronic device by:
initiating the selling request by a seller for the electronic device;
requesting a dashboard interface from the server by the seller on the seller device;
adding selling information of the electronic device on a seller dashboard for selling the electronic device;
posting an advertisement deal for the electronic device by the seller with an expected price for the electronic device;
receiving a buying request from a one or more buyers for the electronic device;
connecting the seller with the one or more buyers via the communication interface;
receiving an offer from the one or more buyers for the electronic device;
accepting the offer of an at least one buyer for the electronic device; and
facilitating a transaction between the at least one buyer and the seller for the electronic device:
wherein the seller pays a transaction fee for the transaction between the at least one buyer and the seller for the electronic device.

5. The intelligent system as claimed in claim 1, wherein a buyer module is operably configured to buy electronic device by:
initiating a buying request by a buyer for the electronic device;
requesting a dashboard interface from the server on the buyer device to view a list of plurality advertisement deals for the electronic device posted by a seller;
selecting an advertisement deal from the list of plurality advertisement deals for the electronic device;
comparing the electronic device with an electronic devices of same/similar kind based on one or more comparison features to make an offer;
sending the offer to the seller based on the advertisement deal selected for the electronic device; and
completing a transaction between the buyer and the seller by facilitating a payment for the electronic device;
wherein the payment is done through anyone payment method selected from an internet banking, a debit card payment, a credit card payment, a smart wallet, a digital wallet or a unified payment interface (UPI) and alike payment methods.

6. The intelligent system as claimed in claim 1, wherein the anti-theft module is operably configured to determine whether the electronic device is a stolen electronic device or not by executing following steps:
checking an authentication database for an International Mobile Equipment Identity (IMEI) number of the electronic device;
verifying the International Mobile Equipment Identity (IMEI) number from the authentication database with the International Mobile Equipment Identity (IMEI) number on the electronic device; and
determining whether verification of the International Mobile Equipment Identity (IMEI) number is successful verification or an unsuccessful verification;
wherein on the successful verification of the International Mobile Equipment Identity (IMEI) number the anti-theft module authenticates and accepts the electronic device as a not stolen electronic device and on the unsuccessful verification of the International Mobile Equipment Identity (IMEI) number the anti-theft module rejects the electronic device as the stolen electronic device.

7. The intelligent system as claimed in claim 1, wherein a repairing module is configured to execute the computer-executable instructions by:
initiating the repairing request by the user for the electronic device based on the diagnosis report;
automatically determining one or more nearby repair stores for repairing of at least one damaged component of the electronic device based on a GPS location of the electronic device and a geographical location of a user;
recommending and displaying the one or more nearby repair stores on a dashboard interface in anyone of view selected from a list view and a map view; and
selecting at least one nearby mobile repair shop from the one or more nearby repair stores to view a nearby mobile repair shop information;
wherein the nearby mobile repair shop information includes name and description, an exact location, a distance from the user, a contact number, a rating and images of nearby mobile repair shop.

8. The intelligent system as claimed in claim 1, wherein a recycling module is configured to initiate the recycling request and specify a device specific detail including a quantity of electronic devices, a model of electronic device, a condition of the electronic device, a mode of shipment, a shipment date, a shipment time and alike electronic device details in the recycling request.

9. The intelligent system as claimed in claim 1, wherein a lost mode module enables a seller to lock the electronic device by sending a lock command and disabling the electronic device when the electronic device is lost and/or stolen and/or not delivered to a buyer.

10. The intelligent system as claimed in claim 1, wherein the intelligent system further comprises an artificial intelligence (AI) Chat bot adapted to be utilized by a buyer via the buyer device for automatically negotiating the price of the electronic device with a seller.

11. A method for recommending a user to perform a user action based on a price determined for an electronic device, wherein the method comprising steps of:
authenticating and verifying the electronic device by an anti-theft module;
evaluating a condition of the electronic device on a one or more evaluating features to determine the price of the electronic device;
issuing a diagnosis report informing the user a status of working features of the electronic device;
determining the price for the electronic device based on the diagnosis report;
certifying the electronic device as a buy certified electronic device, a sell certified electronic device, and a repair certified electronic device;
recommending the user to perform the user action selected from selling, buying or repairing based on the price determined for the electronic device;
initiating a request selected from a selling request, a repairing request, and a recycling request to perform a user action; and
performing the user action selected from selling, repairing or recycling of the electronic device.

12. The method as claimed in claim 11, wherein the certifying the electronic device further comprising steps of:
comparing a market price of the electronic device with the price determined for the electronic device; and
determining using a determination marker whether the price determined of the electronic device is higher than market price, lower than market price, similar to market price.

13. The method as claimed in claim 12, wherein if the price determined by the determination marker for the electronic device is similar to market price or higher than market price then user initiates the selling request for the electronic device; and when the price determined by the determination marker for the electronic device is lower than market price then the user initiates the recycling request.

14. The method as claimed in claim 11, wherein the method is further configured to authenticate and verify the electronic device by:
checking an authentication database for an International Mobile Equipment Identity (IMEI) number of the electronic device;
verifying the International Mobile Equipment Identity (IMEI) number from the authentication database with the International Mobile Equipment Identity (IMEI) number on the electronic device; and
determining whether verification of the International Mobile Equipment Identity (IMEI) number is successful verification or an unsuccessful verification;
wherein on the successful verification of the International Mobile Equipment Identity (IMEI) number the electronic device is accepted as a not stolen electronic device and on the unsuccessful verification of the International Mobile Equipment Identity (IMEI) number the electronic device is rejected as a stolen electronic device.

15. The method as claimed in claim 11, wherein the method further comprises selling of the electronic device by:
initiating the selling request by a seller for the electronic device;
requesting a dashboard interface from a server by the seller on a seller device;
adding selling information of the electronic device on a seller dashboard for selling the electronic device;
posting an advertisement deal for the electronic device by the seller with an expected price for the electronic device;
receiving a buying request from a one or more buyers for the electronic device;
connecting the seller with the one or more buyers via a communication interface;
receiving an offer from the one or more buyers for the electronic device;
accepting the offer of an at least one buyer for the electronic device; and
facilitating a transaction between the at least one buyer and the seller for the electronic device;
wherein the seller pays a transaction fee for the transaction between the at least one buyer and the seller for the electronic device.

16. The method as claimed in claim 11, wherein the method is configured to perform buying of the electronic device by:
initiating a buying request by a buyer for the electronic device;
requesting a dashboard interface from a server on a buyer device to view a list of plurality advertisement deals for the electronic device posted by a seller;
selecting an advertisement deal from the list of plurality advertisement deals for the electronic device;
comparing the electronic device with the electronic device of same/similar kind based on one or more comparison features to make an offer;
sending the offer to the seller based on the advertisement deal selected for the electronic device; and
completing a transaction between the buyer and the seller by facilitating a payment for the electronic device;
wherein the payment is done through anyone payment method selected from an internet banking, a debit card payment, a credit card payment, a smart wallet, a digital wallet or a unified payment interface (UPI) and alike payment methods.

17. The method as claimed in claim 11, wherein the method is further configured to perform repairing of the electronic device by:
initiating the repairing request by the user for repairing the electronic device based on the diagnosis report;
automatically determining a one or more nearby repair stores for repairing of at least one damaged component of the electronic device based on a GPS location of the electronic device and a geographical location of a user;
recommending and displaying the one or more nearby repair stores on a dashboard interface in anyone of view selected from a list view and a map view; and
selecting at least one nearby mobile repair shop from the one or more nearby repair stores and view a nearby mobile repair shop information;
wherein the nearby mobile repair shop information includes name and description, an exact location, a distance from the user, a contact number, a rating and images of nearby mobile repair shop.

18. The method as claimed in claim 11, wherein the method is further configured to perform the recycling of the electronic device by initiating the recycling request and specifying a one or more device specific details including a quantity of electronic devices, a model of electronic device, a condition of the electronic device, a mode of shipment, a shipment date, a shipment time and alike electronic device details in the recycling request and alike details.

19. The method as claimed in claim 11, wherein the method further comprises a step of disabling the electronic device when the electronic device is lost and/or stolen and/or not delivered to a buyer by sending a lock command by a seller to lock the electronic device.

20. The method as claimed in claim 11, wherein the method comprises a step of automatically negotiating the price of the electronic device by a buyer with a seller using an artificial intelligence (AI) Chat bot.
